(19) United States
(12) Patent Application Publication
(10) Pub. No.: US 2019/0092116 A1
(43) Pub. Date: Mar. 28, 2019

(54) SUSPENSION ASSEMBLY AND METHOD OF MAKING AND USING THE SAME

(71) Applicant: SAINT-GOBAIN PERFORMANCE PLASTICS PAMPUS GMBH, Willich (DE)

(72) Inventors: Christian S. MAGNUS, Mülheim an der Ruhr (DE); Oliver Otto, Kelmis (BE)

(21) Appl. No.: 16/143,564

(22) Filed: Sep. 27, 2018

Related U.S. Application Data
(60) Provisional application No. 62/564,443, filed on Sep. 28, 2017.

(51) Int. Cl. B60G 17/015; B60G 17/018; B60G 17/08

(52) U.S. Cl. CPC B60G 17/0155; B60G 2500/10; B60G 17/08; B60G 17/018

(57) ABSTRACT

An assembly including a hollow outer tube, and a hollow inner tube fitted within the outer tube and adapted to be slidably engageable with the outer tube, and a sensor-less measurement system adapted to measure the capacitance between the inner tube and the outer tube, where relative movement between the inner tube and the outer tube is derived from the change in measured capacitance between the inner tube and the outer tube.

### CROSS-REFERENCE TO RELATED APPLICATION(S)

This application claims priority under 35 U.S.C. § 119(e) to U.S. Patent Application No. 62/564,443 entitled “SUSPENSION ASSEMBLY AND METHOD OF MAKING AND USING THE SAME,” by Christian S. MAGNUS et al., filed Sep. 28, 2017, which is assigned to the current assignee hereof and incorporated herein by reference in its entirety.

### FIELD OF THE DISCLOSURE

This disclosure relates to a suspension assembly and method of making and using the same. By non-limiting example, the suspension assembly can be used in vehicle suspensions and similar applications.

### BACKGROUND

A suspension assembly may be used to connect a vehicle component relative to another vehicle component and provide cushioning or damping to control movement of the components. The suspension assembly can be used in vehicles such as bicycles, motorcycles, ATVs, cars, trucks, SUVs, aircraft, spacecraft, watercraft, or in other vehicles. Typically, a suspension system may allow one component to move past another component, such as between inner component (such as a shaft), to an outer component (such as housing). Continued use of a suspension system may lead to undesired vibration within the vehicle. This vibration, without tuning, may lead to undesirable suspension characteristics such as suspension sag, improper bump absorption, or misalignment between the suspension and means of locomotion for the vehicle, such as wheels. There exists a need to detect undesirable suspension characteristics and provide tuning recommendations for suspension assemblies such as these.

### BRIEF DESCRIPTION OF THE DRAWINGS

The present disclosure may be better understood, and its numerous features and advantages made apparent to those skilled in the art by referencing the accompanying drawings.

FIG. 1 illustrates a schematic side view of a vehicle according to one embodiment.

FIG. 2 illustrates a side perspective view of a suspension assembly and sensor-less measurement system of a vehicle according to one embodiment.

FIG. 3A illustrates a graph of time versus suspension travel for a vehicle provided by the sensor-less measurement system according to one embodiment.

FIG. 3B illustrates a graph of frequency versus Fast Fourier Transformation (FFT) Magnitude for a vehicle provided by the sensor-less measurement system according to one embodiment.

FIG. 4 illustrates a block diagram of a sensor-less measurement system according to one embodiment.

FIG. 5 illustrates a block diagram of a controller of the sensor-less measurement according to one embodiment.

FIG. 6 illustrates a block diagram of a program method for use with the sensor-less measurement according to one embodiment.

FIG. 7 illustrates a block diagram of a program method for use with the sensor-less measurement according to one embodiment.

FIG. 8 illustrates a block diagram of a program method for use with the sensor-less measurement according to one embodiment.

FIG. 9 illustrates a block diagram of a program method for use with the sensor-less measurement according to one embodiment.

FIG. 10 illustrates a block diagram of a program method for use with the sensor-less measurement according to one embodiment.

FIG. 11 illustrates a block diagram of a program method for use with the sensor-less measurement according to one embodiment.

FIG. 12 illustrates a block diagram of a process of use with the system according to one embodiment.

The use of the same reference symbols in different drawings indicates similar or identical embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment. Also, the use of “about” or “substantially” is employed to convey spatial or numerical relationships that describe any value or relationship that does not depart from the scope of the invention.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the suspension assembly arts.

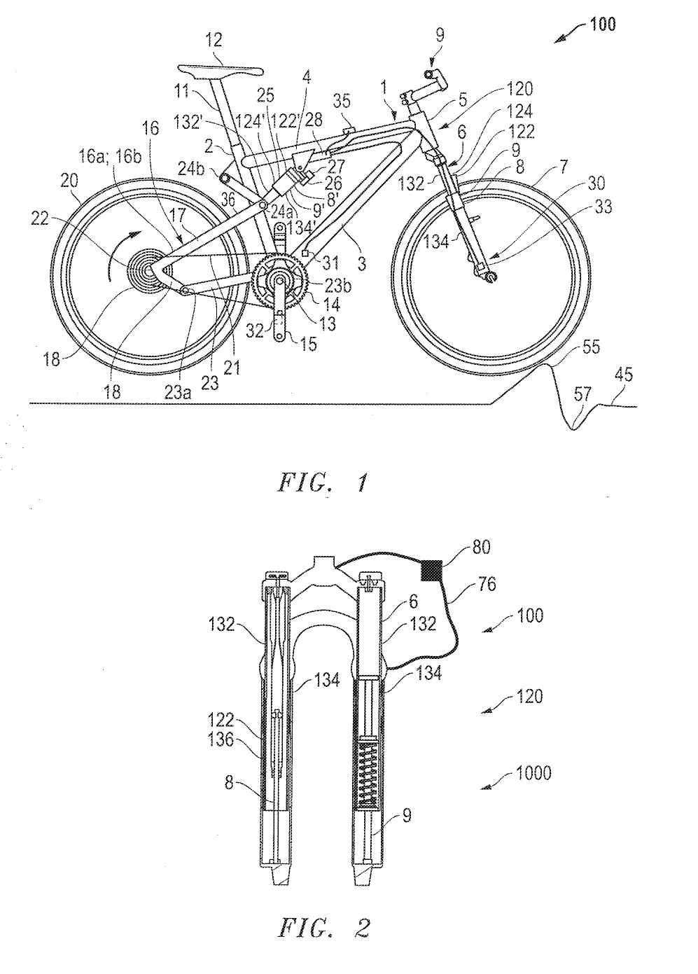

Referring initially to FIG. 1, a vehicle, shown as a bicycle by non-limiting example, generally identified by reference numeral 100 is shown according to a number of embodiments. The vehicle 100 may be a bicycle, motorbike, motorcycle, ATV, car, truck, SUV, aircraft, spacecraft, watercraft, or another type. The vehicle 100 may experience locomotion along a course or terrain 45, which may include a bump 55 or dip 57. The vehicle may include a suspension assembly 120. In a number of embodiments, the suspension assembly 120 may be a part of a bicycle or motorbike or another vehicle 100 suspension. The suspension assembly 120 can include a front suspension and a rear suspension. The suspension assembly 120 can include a frame 1. The frame 1 can have any shape such as a diamond, step-through, cantilever, recumbent, prone, cross or girder, truss, monocoque, folding, penny-farthing, tandem, reclining V shape, reclining L shape or may be a different frame shape as known in the art. In the non-limiting example shown in FIG. 1, the frame 1 can include a triangular chassis 12 including a saddle tube or seat tube 2 that may be generally vertical, an oblique tube or down tube 3 which may be assembled by being welded to the lower end of the saddle tube 2 and a horizontal tube or top tube 4 of which the ends may be assembled by being welded to the upper end of the saddle tube 2 and respectively a fork tube 5 that may be generally vertical, the oblique tube 3 moreover may be secured to said fork tube 5 also by welding. This fork tube or head tube 5 may accommodate a fork 6. The fork 6 may be of the telescopic type supporting at its lower end the axle of the hub of the front wheel 7 of the vehicle 100. The fork 6 may include a suspension assembly shock absorber 122. The suspension assembly shock absorber 122 may include a tube assembly 124. The tube assembly 124 can include at least one inner tube 132 and at least one outer tube 134. The inner tube 132 may be hollow and have a polygonal or substantially circular (including, but not limited to, semi-circular, oval, elliptical, or may be another type) cross-section. The outer tube 134 may be hollow and have a polygonal or substantially circular (including, but not limited to, semi-circular, oval, elliptical, or may be another type) cross-section. In a number of embodiments, the inner tube 132 may be fitted or disposed within the outer tube 134 and be slidably engageable within the outer tube 134. The suspension assembly shock absorber 122 or tube assembly 124 may include a damping element 8. In a number of embodiments, the damping element 8 may be disposed within the outer tube 134 and comprise a fluid disposed within the outer tube 134. In a number of embodiments, the damping element 8 may be adapted to restrict fluid flow so as to damp relative movement between the inner tube 132 and the outer tube 134. The suspension assembly shock absorber 122 or tube assembly 124 may include a spring element 9. In a number of embodiments, the spring element 9 may be disposed within the outer tube 134 and adapted to provide a spring force between the inner tube 132 and the outer tube 134. Together, the spring element 9 and the damping element 8 may form a shock absorber 122. The shock absorber 122 may be of any type conventional in the art including, a mechanical spring type, a gas spring type, a selectively adjusting type, a “lock out” type, or may be another type. The spring element 9 may be adjustable so as to vary spring rates, thereby giving the shock absorber 122 an adjustability that may be preset to varying initial states of compression. In some instances the spring element 9 (gas or mechanical) may comprise different stages having varying spring rates thereby giving the overall shock absorber 122 a compound spring rate varying through the stroke length. In that way the shock absorber 122 can be adjusted to accommodate heavier or lighter carried weight, or greater or lesser anticipated impact loads. In vehicle 100 applications, including motorcycle and bicycle applications and particularly off-road applications, shock absorbers 122 may be pre-adjusted to account for varying terrain and anticipated speeds and jumps. Shock absorbers 122 may also be adjusted according to certain rider preferences (e.g. soft—firm). In a number of embodiments, the shock absorber 122 may include an “adjustable intensifier assembly” which accepts damping fluid during a compression stroke of the shock 122 via an intensifier valve assembly. In a number of embodiments, the position of the inner tube 132 or outer tube 134 of the tube assembly 124 may correspond to a stroke of the suspension assembly 120 during compression or rebound of a vehicle 100.

Handlebars 9 may be secured to the distal end of a stem 10 secured to the upper end of the fork 6 in order to steer the vehicle 100. In a number of variations, at least one of the inner tube 132 or outer tube 134 may include a conductive material such as metal including steel, aluminum, bronze, stainless steel, nickel, copper, tin, titanium, platinum, tungsten, or may be another type. In a number of variations, at least one of the inner tube 132, the outer tube 134, or a separate part in contact with one of the tubes 132, 134, may include a polymer including at least one of a polyketone, a polyaramid, a polyimide, a polyetherimide, a polyamideimide, a polyphenylene sulfide, a polyphenylene sulfone, a fluoropolymer, a polybenzimidazole, a derivation thereof, or a combination thereof. In an embodiment, the polymer may include a fluoropolymer. In an embodiment, the polymer may include polytetrafluoroethylene (PTFE), modified polytetrafluoroethylene (mPTFE), ethylene-tetrafluoroethylene (ETFE), perfluoroalkoxyethylene (PFA), tetrafluoroethylene-hexafluoropropylene (FEP), tetrafluoro-ethylene-perfluoro (methyl vinyl ether) (MFA), polyvinylidene fluoride (PVDF), ethylene-chlorotrifluoroethylene (ECTFE), polyimide (PI), polyamidimide (PAI), polyphenylene sulfide (PPS), polyethersulofone (PES), polyphenylene sulfone (PPSO2), liquid crystal polymers (LCP), polyetherketone (PEK), polyether ether ketones (PEEK), aromatic polyesters (Ekonol), of polyether-ether-ketone (PEEK), polyetherketone (PEK), liquid crystal polymer (LCP), polyimide (PA), polyoxymethylene (POM), polyethylene (PE)/UHMPE, polypropylene (PP), polystyrene, styrene butadiene copolymers, polyesters, polycarbonate, polyacrylonitriles, polyamides, styrenic block copolymers, ethylene vinyl alcohol copolymers, ethylene vinyl acetate copolymers, polyesters grafted with maleic anhydride, poly-vinylidene chloride, aliphatic polyketone, liquid crystalline polymers, ethylene methyl acrylate copolymer, ethylene-norbomene copolymers, polymethylpentene and ethylene acyrilic acid copoloymer, mixtures, copolymers and any combination thereof.

Still referring to FIG. 1, in a number of embodiments, the saddle tube 2 may be capable of accommodating a saddle stem 11 including, at its upper end, a saddle 12 on which a vehicle user takes position. The various tubes, saddle tube 2, oblique tube 3, horizontal tube 4, and fork tube 5, of the tube assembly or frame 1, may be assembled by any appropriate means well known to those skilled in the art such as by bonding and or by interlocking for example. The lower end of said saddle tube 2, that is to say the intersection of the oblique tube 3 and of the saddle tube 2, may include a crankset 13 supporting the axle of drive pinions 14 or chainrings, the axes of rotation of which may be coaxial. Pedals 15 may be secured to the axle of the drive pinions 14 on either side of the frame 1 of the vehicle 100.

In a number of embodiments, the vehicle 100 may also include a rear triangle 31. The rear triangle 31 may be rigid and connected to the other aspects of the frame 1 by any appropriate means well known to those skilled in the art such as by bonding and or by interlocking for example. In an embodiment, as shown in FIG. 1, the rear triangle 31 may include a swing arm 16 consisting of two assemblies 16a, 16b, in the shape of a V extending on either side of the mid-plane of the frame 1. The assemblies 16a, 16b may also be connected by one or more crossmembers not shown in FIG. 1. Each assembly 16a, 16b of the swing arm 16 may include an oblique tube 17 called the seat stay and a lower tube 18 may be connected in twos by welds. The intersection of the seat stay 17 and the lower tube 18 may support the axle of the hub 19 of the rear wheel 20. In a number of embodiments, the rear wheel 20 may be rotated by a transmission chain 21 extending between the drive pinions 14 of the crankset 13 and driven pinions 22 supported by the axle of the hub 19 of the rear drive wheel 20 when the cyclist pedals. The swing arm 16 can have any shape such as a generally triangular shape, generally rectilinear shape, or may be a different frame shape as known in the art. In a number of embodiments, the swing arm 16 may be secured to the frame 1 by two articulation points/means 23 and 24. The first articulation point/means 23 may include a lower link rod 23 of which the rotation axles 23a and 23b positioned at the free ends of said link rod 23 may be respectively articulated at the free end of the lower tube 18 of the swing arm 16 to the saddle tube 2 close to the crankset 13. The first articulation point/means 24 may include an upper link rod 24 of which the rotation axles 24a, 24b positioned at the ends of said upper link rod may be respectively articulated at the anterior free end of the seat stay 17 of the swing arm 16 and on the saddle tube 2, beneath the horizontal tube 3 of the frame 1. In a number of embodiments the articulation means 23, 24, could be substituted by other equivalent articulation means such as an eccentric, a flexible strip or similar elements, without however departing from the context of the invention.

In a number of embodiments, the vehicle 100 may also include a rear suspension assembly shock absorber 122′. The rear suspension assembly shock absorber 122′ may be disposed in the rear suspension of the vehicle 100. The rear suspension assembly shock absorber 122′ may include a tube assembly 124′. The tube assembly 124′ can include at least one inner tube 132′ and at least one outer tube 134′. The inner tube 132′ may be hollow and have a polygonal or substantially circular (including, but not limited to, semi-circular, oval, elliptical, or may be another type) cross-section. The outer tube 134′ may be hollow and have a polygonal or substantially circular (including, but not limited to, semi-circular, oval, elliptical, or may be another type) cross-section. In a number of embodiments, the inner tube 132′ may be fitted or disposed within the outer tube 134′ and be slidably engageable within the outer tube 134′. The rear suspension assembly shock absorber 122′ or tube assembly 124′ may include a damping element 8′. In a number of embodiments, the damping element 8′ may be disposed within the outer tube 134′ and comprise a fluid disposed within the outer tube 134′. In a number of embodiments, the damping element 8′ may be adapted to restrict fluid flow so as to damp relative movement between the inner tube 132′ and the outer tube 134′. The rear suspension assembly shock absorber 122′ or tube assembly 124′ may include a spring element 9′. In a number of embodiments, the spring element 9′ may be disposed within the outer tube 134′ and adapted to provide a spring force between the inner tube 132′ and the outer tube 134′. Together, the spring element 9′ and the damping element 8′ may form a shock absorber 122′. In a number of variations, at least one of the inner tube 132′ or outer tube 134′ may include a conductive material such as metal including steel, aluminum, bronze, stainless steel, nickel, copper, tin, titanium, platinum, tungsten, or may be another type. In a number of variations, at least one of the inner tube 132′ or the outer tube 134′ may include a polymer including at least one of a polyketone, a polyaramid, a polyimide, a polyetherimide, a polyamideimide, a polyphenylene sulfide, a polyphenylene sulfone, a fluoropolymer, a polybenzimidazole, a derivation thereof, or a combination thereof. In an embodiment, the polymer layer 20 or secondary polymer layer 220 may include a fluoropolymer. In an embodiment, the polymer layer 20 or secondary polymer layer 220 may include polytetrafluoroethylene (PTFE), modified polytetrafluoroethylene (mPTFE), ethylene-tetrafluoroethylene (ETFE), perfluoroalkoxyethylene (PFA), tetrafluoroethylene-hexafluoropropylene (FEP), tetrafluoro-ethylene-perfluoro (methyl vinyl ether) (MFA), polyvinylidene fluoride (PVDF), ethylene-chlorotrifluoroethylene (ECTFE), polyimide (PI), polyamidimide (PAI), polyphenylene sulfide (PPS), polyethersulofone (PES), polyphenylene sulfone (PPSO2), liquid crystal polymers (LCP), polyetherketone (PEK), polyether ether ketones (PEEK), aromatic polyesters (Ekonol), of polyether-ether-ketone (PEEK), polyetherketone (PEK), liquid crystal polymer (LCP), polyimide (PA), polyoxymethylene (POM), polyethylene (PE)/UHMPE, polypropylene (PP), polystyrene, styrene butadiene copolymers, polyesters, polycarbonate, polyacrylonitriles, polyamides, styrenic block copolymers, ethylene vinyl alcohol copolymers, ethylene vinyl acetate copolymers, polyesters grafted with maleic anhydride, poly-vinylidene chloride, aliphatic polyketone, liquid crystalline polymers, ethylene methyl acrylate copolymer, ethylene-norbomene copolymers, polymethylpentene and ethylene acyrilic acid copoloymer, mixtures, copolymers and any combination thereof.

In a number of embodiments, the rear suspension assembly shock absorber 122′ may include free ends of which may be secured respectively to the horizontal tube 3 and to the anterior free end of the seat stay 7 of the rear triangle 31 or swing arm 16 or of the upper link rod 24. Note that, as a function of the architecture of the frame 1 and of the swing arm 16, the ends of the rear suspension assembly shock absorber 122′ can be secured to a transfer link rod and respectively to any one of the tubes of the frame 1. In other words, the suspension assembly shock absorber 122 may be placed anywhere on the frame 1 or suspension assembly 120 within the vehicle 100. Further, a single vehicle 100 may include a plurality of suspension assemblies 120, 120′ as shown. The inner tube 132′ and outer tube 134′ in the rear suspension assembly shock absorber 122′ may act in a substantially similar way as the inner tube 132 and outer tube 134 formed in the suspension assembly shock absorber 122.

As stated above, the frame 1 can include a suspension assembly 120 having a swing a swing arm assembly 16 that, in use, may be able to move relative to the rest of the frame; this movement may be permitted by, inter alia, the rear suspension assembly shock absorber 122′. The front fork 6 also provide a suspension function via a the suspension assembly shock absorber 122 in at least one fork leg; as such the vehicle 100 may be a full suspension bicycle (such as an ATB or mountain bike), although the embodiments described herein are not limited to use on full suspension bicycles. In particular, the term “suspension system” is intended to include vehicles having front suspension or rear suspension only, or both and other systems wherein motion damping may be included (such as for example vehicle steering dampeners or machine part motion dampeners). In a number of embodiments, the frame 1 or suspension assembly 120 can be made of any material commonly known in the vehicle arts. In a number of embodiments, the frame 1 or suspension assembly 120 may be made of a material conventional in the art such as, but not limited to, a metal or metal alloy, a polymer, or a composite material. The frame 1 or suspension assembly 120 may be a metal including steel, aluminum, bronze, stainless steel, nickel, copper, tin, titanium, platinum, tungsten, or may be another type. The frame 1 or suspension assembly 120 may include a carbon based compound such as carbon fiber. In an embodiment, the frame 1 or suspension assembly 120 may be manufactured by a method conventional in the art such as, but not limited to, metalworking, forming, forging, extrusion, molding, printing, or may be another type. Further, the dimensions of the frame 1 or suspension assembly 120 may be any commonly known in the vehicle art. Commonly, the lengths and diameters of the frame 1 and/or suspension assembly 120 may be adjusted to fit the user of the vehicle 100.

In an embodiment, the suspension assembly 120 may include a lubricant on any of its components. The lubricant may include a grease including at least one of lithium soap, lithium disulfide, graphite, mineral or vegetable oil, silicone grease, fluorether-based grease, apiezon, food-grade grease, petrochemical grease, or may be a different type. The lubricant may include an oil including at least one of a Group I-GroupIII+ oil, paraffinic oil, naphthenic oil, aromatic oil, biolubricant, castor oil, canola oil, palm oil, sunflower seed oil, rapeseed oil, tall oil, lanolin, synthetic oil, polyalpha-olefin, synthetic ester, polyalkylene glycol, phosphate ester, alkylated naphthalene, silicate ester, ionic fluid, multiply alkylated cyclopentane, petrochemical based, or may be a different type. The lubricant may include a solid based lubricant including at least one of lithium soap, graphite, boron nitride, molybdenum disulfide, tungsten disulfide, polytetrafluoroethylene, a metal, a metal alloy, or may be a different type.

The spring element 9, 9′ may have a spring force of at least 0.1 N, at least 1 N, at least 5 N, at least 10 N, at least 1000 N, at least 1000 N, at least 10000 N. The spring element 202 may have a spring rate of at least about 1 N/mm, about 10 N/mm, about 25 N/mm, about 50 N/mm, about 100 N/mm, about 200 N/mm, about 500 N/mm, about 1000 N/mm, about 2000 N/mm, about 5000 N/mm, about 10000 N/mm.

In an embodiment, the suspension assembly 120 can be installed or assembled by an assembly force of at least 1 kgf in a longitudinal direction relative to the shaft 4 or housing 8, such as at least 2 kgf, at least 3 kgf, at least 4 kgf, at least 5 kgf, at least 10 kgf, or even at least 15 kgf. In a further embodiment, the suspension assembly 120 can be installed or assembled by an assembly force of no greater than 20 kg in a longitudinal direction to the housing 8, such as no greater than 19 kgf, no greater than 18 kgf, no greater than 17 kgf, or even no greater than 16 kgf.

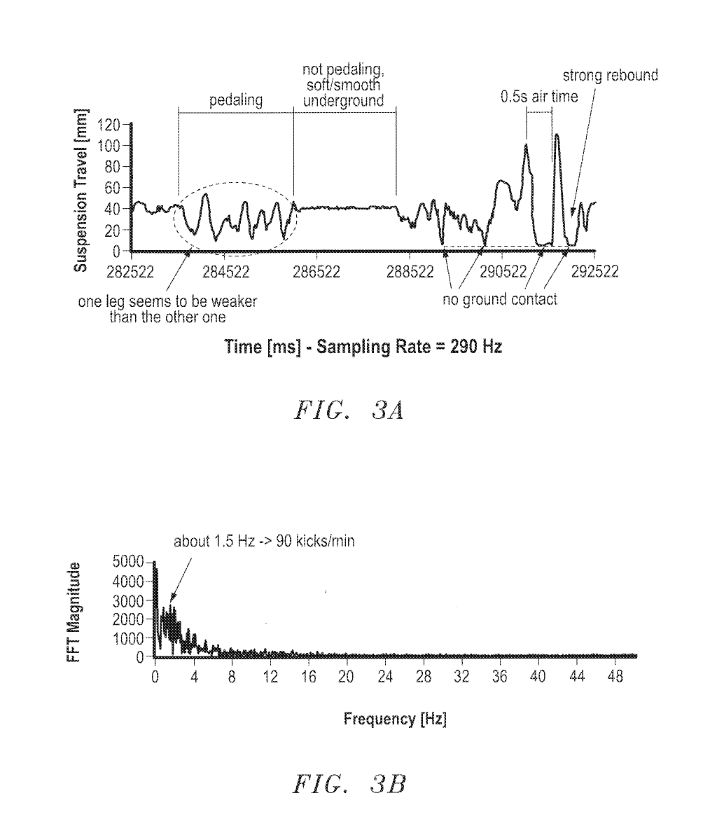

In a number of embodiments, as shown in detail in FIG. 2, the suspension assembly 120 may further include a sensor-less measurement system 1000. The sensor-less measurement system 1000 may be adapted to measure the capacitance between the inner tube 132 and outer tube 134 within the tube assembly 124 and derive the relative movement between the inner tube 132 and outer tube 133 from a change in measured capacitance between the inner tube 132 and the outer tube 134 as explained below. In the suspension assembly 120 it may be desirable to know the relative position of the inner tube 132 relative to the outer tube 134 or vice versa. In a number of embodiments, the inner tube 132 may create an electrical capacitance proportional to the relative position of the inner tube 132 relative to the outer tube 134. In a number of embodiments, the outer tube 134 may create an electrical capacitance proportional to the relative position of the outer tube 134 relative to the inner tube 132. Because at least one of the inner tube 132 or outer tube 134 may be fixed to the frame 1 within the suspension assembly shock absorber 122, 122′ the position of the other of the inner tube 132 or the outer tube 134 may be directly proportional to the vibration of the suspension assembly 120 or the vehicle 100 as a whole. As a result, in a number of embodiments, relative movement between the inner tube and the outer tube 134 may be derived from the change in measured capacitance between the inner tube 132 and the outer tube 134.

As described above, electrical capacitance of the inner tube 132 and the outer tube 134 may be proportional to the relative position and movement of at least one of the inner tube 132 or outer tube 134 within the suspension assembly 120. In a number of embodiments, a dielectric gap 136 may exist between the inner tube 132 and the outer tube 134. In a number of embodiments, the dielectric gap 136 may be at least 0.1 mm, at least 0.2 mm, at least 0.5 mm, at least 0.7 mm, at least 1 mm, at least 1.5 mm, or at least 2 mm wide. In a number of embodiments, the dielectric gap 136 may be no greater than 5 mm, no greater than 4.5 mm, no greater than 3 mm, no greater than 2.5 mm, no greater than 2 mm, or no greater than 1.5 mm. In a number of embodiments, the dielectric gap 136 may exist between the inner tube 132 and the outer tube 134 in the radial direction. The dielectric gap 136 may include a dielectric material 137. The dielectric material 137 may be a non-conductive material such as, but not limited to, a fluid (such as air, gas, water, compressed air, foam, polymer, or may be another type). In a number of embodiments, the dielectric material 137 may be a may include a conductive material such as metal including steel, aluminum, bronze, stainless steel, nickel, copper, tin, titanium, platinum, tungsten, or may be another type. In a number of embodiments, the dielectric gap 136 may be filled with two dielectric materials (such as, but not limited to, air and aluminum). In a number of embodiments, no electric shortcut may exist between the inner tube 132 and the outer tube 134.

The capacitance formed between the inner tube 132 and the outer tube 134 may be calculated by the expression:

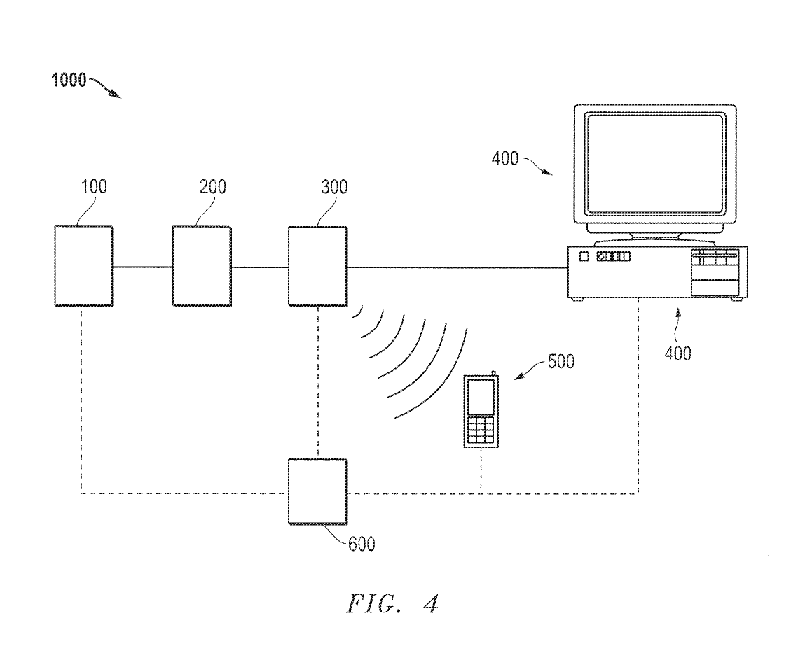

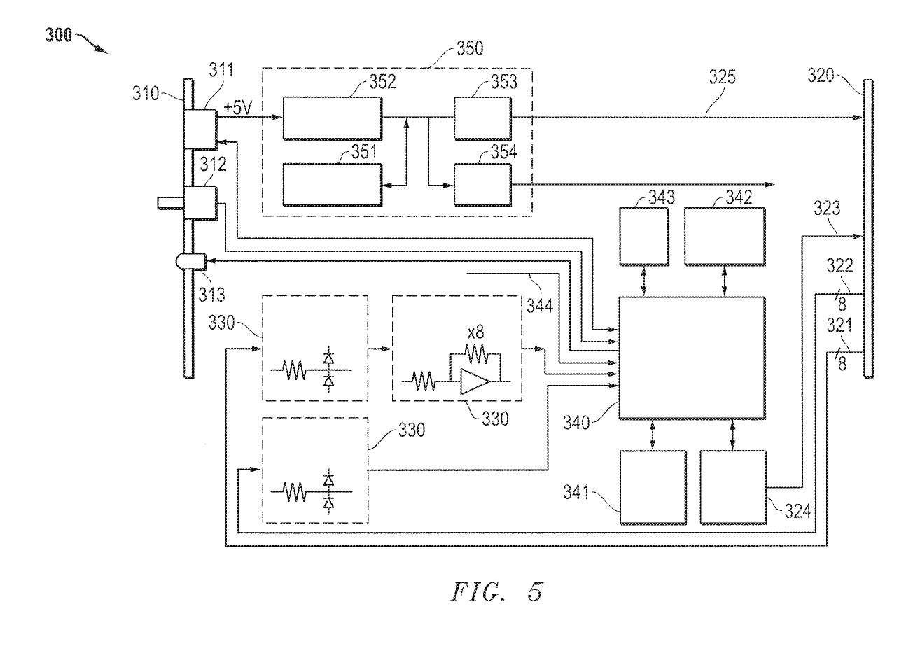

C=2*π*ER*E0*L/ln(r2/r1)where C is the capacitance in picoFarads/foot, ER is the dielectric constant (relative to vacuum) of the dielectric material 137 used to fill the dielectric gap 136, E0 is the electric constant, L is the length of the interface between the inner tube 132 and the outer tube, and (r2/r1) is the ratio of the inner radius of the outer tube and the outer radius of the inner tube 132, 134, respectively. It can therefore be seen that a linear change in capacitance between the inner tube 132 and the outer tube 134 will occur which is proportional to the amount of relative movement of the inner tube 132 relative to the outer tube 134, or the outer tube 134 relative to the inner tube 132. In a number of embodiments, as shown in FIG. 2, the sensor-less measurement system 1000 may include an electrical contact 76. The electrical contact 76 may be established with at least one of the inner tube 132 or the outer tube 134. In a number of variations, the electrical contact 76 may be a conductive material. In a number of variations, the electrical contact 76 may be a wire. In a number of embodiments, as shown in FIG. 2, the sensor-less measurement system 1000 may include a measurement device 80. The measurement device 80 may be coupled to the electrical contact 76. The measurement device 80 may measure the capacitance between the inner tube 132 and the outer tube 134. In a number of variations, the measurement device 80 may include a conductive material. The conductive material may be any material capable of conducting electricity. Since the position of at least one of the inner tube 132 or outer tube 134 may be electrically isolated from the body of the tube assembly 124 and coupled to a electrical contact 76 brought outside the tube assembly 124, it may be therefore possible to externally measure the relative positions of inner tube 132 relative to the outer tube 134, or the outer tube 134 relative to the inner tube 132 by measuring the capacitance between them. In a number of embodiments, the measurement device 80 may be integrated within the tube assembly 124. In a number of embodiments, the diameters of the inner tube 132 and the outer tube 134 may be substantially uniform, the change in capacitance during jounce and rebound will be linear and can thus be used to determine the relative positions of the inner tube 132 and the outer tube 134. Additionally, by monitoring the rate of change of the capacitance, the direction of movement, velocity and acceleration of the tubes 132, 134 within the tube assembly 124, or of the tubes 132, 134 may be determined, in addition to its position. Such information can be used by a control system (such as the system of FIG. 4) to change the suspension assembly 120 settings based on this information.

In a number of embodiments, data from the measurement device 80 may by analyzed via a controller and/or a processor 65, or may be overlayed on a common time datum and suspension damping and/or spring effectiveness can be evaluated by comparing the data from the tube assemblies 122, 122′ on either “side” of the suspension assembly 120. In a number of embodiments, the controller and/or processor 65 may be in the measurement device 80. In a number of embodiments, the controller or processor 65 and/or measurement device 80 may be a microcontroller. The processor or controller 65 may take the data from the measurement device 80 and uses an algorithm for weighting their respective inputs and generating a resulting singular command or signal based on a predetermined logic. In a number of embodiments, a remote lock/unlock function (known conventionally through a valve or intensifier assembly) on the shock absorber 122, 122′ may be engaged through data from the measurement device 80 through the processor 65 (e.g. comprising a memory and a processor/microprocessor, or an ASIC). In a number of embodiments, the tuning of the shock absorber 122 or the suspension assembly 120 itself may be tuned based on analysis of data from the sensor-less measurement system 1000. In a number of embodiments, a remote lock/unlock of the shock absorber 122, 122′ may be carried out manually by a user based on data sent to the measurement device.

In one embodiment, the measurement device 80, controller/processor 65, or both may comprise a digital user interface device provided with buttons and/or a touch screen enabling the user to lock and unlock the damping assembly at will. The measurement device 80, controller/processor 65, or both may comprise a suitable GPS unit, bicycle computer, heart rate monitor, smart phone, personal computer, cloud connected computer and may further comprise connectivity to the internet. The measurement device 80, controller/processor 65, or both may send and receive data via cell phone bands, satellite bands or other suitable electromagnetic frequencies to connect with other computer networks for the sending and or receiving of data wherein the data may be received by and transformed by an outside computing machine and transmitted to the measurement device 80, controller/processor 65, or both may comprise in an altered form or in a new form corresponding to the result of the outside machine transformation. The functionality of the measurement device 80, controller/processor 65, or both may be incorporated into performance recording devices and/or digital user interfaces, such as, but not limited to, the GARMIN EDGE series of devices, and cellular phones such as the Apple iPhone, Samsung Galaxy, or Google Pixel.

In a number of embodiments, some or all of components of embodiments herein including, measurement device 80, processor or controller 65, shock absorber 122, 122′, tube assembly 124, 124′ (including the inner tube 132 and/or outer tube 134), suspension assembly 120, and/or intensifier assembly, may be interconnected or connected by an electrical contact, which may include wire 76, wireless, WAN, LAN, Bluetooth, Wi-Fi, ANT (i.e. GARMIN low power usage protocol), or any suitable power or signal transmitting mechanism. In certain embodiments the measurement device 80 may communicate wirelessly with the controller 65. An output electric signal from the device 80 may be transmitted to the controller 65. The controller 65 responds to that signal by adjusting the shock absorber 122, 122′ to lock or unlock, and/or set at some intermediate level according to the output electric signal based on the measurement of capacitance from the tube assembly 124, 124′ within the shock absorber 122, 122′.

It is noted that embodiments herein of shock absorber 122, 122′ and related systems may be equally applicable to the vehicle 100, such as bicycle 100, front fork tubes 5. Further, it is contemplated that the bicycle 100 may include both shock absorber 122, 122′ and front fork tubes 5, both of which having some or all of the features disclosed herein.

FIG. 4 illustrates a system 1000 according to one embodiment. The system 1000 may include a vehicle 100 (such as vehicle 100 described above), the tube assembly 124, 124′ (including the inner tube 132 and the outer tube 134), a processor or controller 300 (such as processor and/or controller 65 (or may be or include the measurement device 80 described above), a computer system 400, and a communication device 500 (such as measurement device 80 described above). An operator or user 600, such as a rider/operator of the vehicle 100, may use the system 1000 according to the embodiments described herein. In one embodiment the vehicle 100, such as a bicycle, may be equipped with the processor 65, such as a suspension setup microcomputer device comprising at least one memory, program having an algorithm and computer for executing the program, which captures data in the memory from the tube assembly 120 that may be coupled to one or more vehicle 100 suspension components (such as a fork tube 5 with a shock absorber 122 and rear shock 122′ on a bicycle or motorcycle). The data may include suspension component relative position data (e.g. inches of compression or full extension or full compression or any suitable combination of such data) and/or other operational characteristics/features of the vehicle 100 that may be measured by the tube assembly 122 (i.e. capacitance between the inner tube 132 and the outer tube 134). The data may be communicated to the controller 65 via wired and/or wireless communication, and the controller 65 may process the data and communicate the data via for example an industry standard, low power wireless protocol to the communication device 500, such as an external third party device with a display, to instruct the user 600 on what adjustments to make to improve the vehicle 100 suspension assembly 120 setup and/or to describe the current performance of the vehicle 100 suspension assembly 120. In one embodiment, the user 600 may use the computer system 400 and/or the communication device 500 to adjust one or more components of the vehicle 100, automatically, manually and/or remotely, wired and/or wirelessly, directly, manually and/or indirectly (such as via the controller 300) during and/or after operation of the vehicle 100.

In a number of embodiments, the system 1000 may be used to monitor displacement of the vehicle suspension 120, or may monitor another variable of the vehicle 100. The system 1000 may be operable to measure an operational characteristic of the vehicle 100 directly or indirectly (e.g. inferred from the position of the tube assembly 124, 124′, such as the position of a vehicle suspension 120 linkage, or the sprung versus un-sprung portion of a vehicle component 100 for example. The system 1000 may be used to determine the position, velocity, and/or acceleration of the suspension assembly 120 component (raw tube assembly data may be used to calculate such parameters within the processor 65). The system 1000 may be further used to gain insights to, for example, kicks per minute for a user of the vehicle 100, state of the thoroughfare (i.e., thoroughfare surface) on which the vehicle 100 is currently on. The system 1000 may further include a linear potentiometer, a string potentiometer, a contact or non-contact membrane potentiometer, a rotary potentiometer (such as if used on a linkage fork or a rear suspension linkage), an accelerometer or accelerometers, a 3D global position instrument (“GPS”), a pressure measurement device (for measuring the air spring or coil spring compression), and/or other type of system 1000 from which a damping component 8, 8′ position within the tube assembly 124, 124′ of the vehicle 100 can be determined.

The tube assembly 122 may communicate either wired or wirelessly to the controller 300, such as a microcomputer device, to communicate the sag position or any other suitable data regarding the vehicle 100 or suspension assembly 120. Due to potentially high sampling rate requirements associated with suspension 120 movement and power considerations (e.g. economy), it may be preferable at this time to communicate from the tube assembly 120 to the controller 300 via one or more wires 76 (which can for example carry more data than wireless), including electrical and fiber optical wires 76, for example as shown in FIG. 2. It is expected that in the future wireless protocols and battery life may be such that wireless high speed communication (although possible today) between the tube assembly 122 and the controller 300 will become more practical and is therefore contemplated hereby. In one embodiment, the data sampling rate may be about 8-800 Hz to allow sufficient sampling and resolution of the vehicle suspension movement during operation. In an embodiment, as shown in FIGS. 3A-3B, the sampling rate may be 290 Hz.

In one embodiment, the controller 300 may be relatively small (about 2″×3-3.5″×0.5-0.625″) and lightweight so as to not negatively impact the user 600 of the vehicle 100. In one embodiment the controller 300 need not literally “control” anything but rather may cull data and send the result to the device 80 or 500. In a number of embodiments, the controller 300 may be included in the measurement device 80 or 500 itself. In one embodiment, the controller 300 may contain one or more of the following major components: a low power microprocessor, a wireless communication chip (such as ANT+, Bluetooth, and/or Wi-Fi 802.11 n), a battery, an energy harvesting system, an energy management system, a removable or fixed data storage system, or flash memory. The controller 300 may also have other measurement devices on board such as a GPS, a compass, an accelerometer, an altimeter, and/or an air temperature measurement device. The controller 300 may also have one or more external features such as multi-color LED's to communicate basic state of operation and battery charge to the user 600, and buttons to toggle power and start/stop data logging. The controller 300 may also have an external mini USB connector to connect to a computer, such as the computer system 400, for uploading of data and charging the battery. The controller 300 may also have external connectors to connect to any other electronic devices.

In one embodiment, the controller 300 (such as a computer or a microcomputer) may record and evaluate the typically high frequency vehicle 100 suspension 120 data in real time. The controller 300 may analyze parameters like sag (static ride height), rebound and compression speed, top out and bottom out events. Then, after analysis is complete, the controller 300 may communicate to the communication device 500, such as an external 3rd party user interface device (e.g. 80 or 500), via an industry-standard, lower power wireless communication protocol in simple and small data packets at about 1 Hz to about 10 Hz. Because there may be many user interface devices that already have ANT+ and/or Bluetooth built in (e.g. Garmin GPS, power meters, Smartphone/mobile phone and iPod, etc.) it is contemplated that certain embodiments hereof will be so compatible. These interface devices generally have large displays with a developed GUI and user navigation method via any or all of buttons, joystick, touch screen, etc. The built in wireless capabilities may be ideal for low density data transmittal, but may be not well suited for high speed data acquisition (because low power wireless data rates may be generally limited). By leveraging the existing device (e.g. 500) display and GUI capabilities, the applicability of the system is increased. In one embodiment the device 500 may be programmed with a data template or templates suitable for filling with data and/or calculations/suggestions from the controller 300. In one embodiment the device 500 may be programmed with input templates for facilitating user input of suspension model, user weight, vehicle type, etc. as may be useful in aiding the controller to look up corresponding parameters. The controller 300 will communicate to the communication device 500 selected data or calculations (e.g. graphical, tabular, textual or other suitable format) to display to the user 600, such as suggestions for adjusting spring preload, air spring pressure (to adjust sag), rebound damping setting, compression damping setting, bottom out damping component 8, 8′ setting, etc. Communication will also work in reverse to allow the user 600 to enter data, such as model of suspension, rider weight, etc., in the communication device 500 which will relay the information to the controller 300. From such model information the controller 300 will look up model relevant parameters and use those to aid in calculating suggestions. FIGS. 3A-3B show indication of this connection as suspension travel, as shown in FIG. 3A, is monitored.

In one embodiment, the controller 300 functions as a data receiver, processor, memory and data filter. The controller 300 receives high frequency (high sampling rate) data from the tube assembly 124, 124′. Because current user interface devices, particularly those using wireless protocol, may not be capable of high enough data rates to directly monitor the tube assembly 124, 124′, the controller may act as a high data rate intermediary between the tube assembly 124, 124′ and the communication device 500. In one embodiment, the controller 300 may be configured to prompt and accept high sampling rate data from the tube assembly 124, 124′. The controller 300 then stores the data and processes selected data at selected intervals for transmission to a user interface of the communication device 500, for example. In other words the controller 300 pares the effective data rate and makes that pared data transmission to the user interface in real time. Additionally, the controller 300 stores all un-transmitted data for later analysis if desired. The controller 300 can later be plugged into the computer system 400, such as a home computing device or laptop via a USB pigtail or dongle device. The controller 300 may also preprocess data and generate user friendly viewing formats for transmission to the user interface of the communication device 500. The controller 300 may calculate data trends of other useful data derivatives for periodic “real time” (effectively real time although not exact) display on the user interface of the communication device 500.

In one embodiment, each vehicle 100 suspension assembly 120 component may be equipped with a tube assembly 124, 124′ (including an inner tube 132 and an outer tube 134) for indicating the magnitude (or state) of extension or compression existing in the vehicle 100 suspension assembly 120 at any given moment. As the suspension assembly 120 may be used over terrain, such a tube assembly 124, 124′ will generate a tremendous amount of data. Relatively high sampling rates may be needed to capture meaningful information in devices operating at such high frequencies.

In one embodiment, the controller 300 operates in set up mode where it uses rider input weight and suspension assembly 120 data to suggest initial spring element 9, 9′ preload and damping component 8, 8′ settings for the vehicle 100 suspension assembly 120. In one embodiment, the controller 300 operates in a ride mode wherein it monitors suspension assembly 120 movement (e.g. average travel used versus available, portion or range of travel used, number and severity of bottom out or top out events) and then uses that data in conjunction with the rider and suspension assembly 120 data to suggest changes to the suspension 120 set up that better utilize or maximize usage of the suspension 120 capabilities. In one embodiment the controller 300 monitors compression range of the suspension assembly 120 to determine whether or not the suspension assembly 120 is set up for optimal use of its range over a given terrain. Too many top out events or bottom out events or operation generally over only a portion of the available range will indicate a possibly needed adjustment to the spring pressure and/or damping rate and the controller 300, upon calculating such range usage sends an appropriate suggestion to the device 500. In one embodiment a GPS unit of, for example the device, transmits real time GPS data to the controller 300 and such data may be overlayed or paired with corresponding suspension 120 data along an elapsed (or relative sequence) time (or other suitable common data marker or “datum” type) synchronous data marker.

In one embodiment, rebound setting can be automatically achieved by utilizing the air spring pressure or coil spring preload needed to achieve proper sag. The rebound setting may be then achieved via feeding the air spring pressure for an air shock, or an oil pressure signal for a coil shock, down the damping component 8, 8′ shaft to a pressure sensitive damping valve at the damping component 8, 8′ shaft piston. There would still be an external rebound adjustor to make incremental changes from the predetermined setting to account for varied terrain/conditions, and/or riding style and preference. In one embodiment, initial sag in the suspension assembly 120 can be automatically set and facilitated by having a position valve within the shock absorber 122, 122′ for a given length bleed off air pressure until a specific sag level is achieved. Each shock stroke would have a specific length of sag/position valve. The user 600 would pressurize their shock to a maximum shock pressure of, for example, 300 psi or so. The idea is to over pressurize the shock beyond any reasonable properly set sag pressure. The user 600 then switches the shock to be in setup or sag mode. The user 600 then sits on the bike. In one embodiment, the shock will bleed air from the air spring until the position valve encounters a shut off abutment which thereby shuts the bleed valve. In one embodiment, the shock absorber 122, 122′, having a tube assembly 124, 124′ and a controller 300, to measure that compression of the shock 122, 122′ from full extension (or any selected set “zero” position datum), “knows” it is extended beyond a proper sag level and a an electrically actuated valve may be opened to bleed air pressure from the air spring in a controlled manner until the proper predetermined sag level is reached, at which point the valve automatically closes and the shock opts itself out of sag mode. Alternatively, the user 600 can switch the sag set up mode off upon reaching a proper sag setting. In one embodiment, with the controller 300 in normal ride mode the user 600/vehicle 100 will now be in a proper starting point for their sag measurement. When in riding mode, more pressure can be added to the air spring or pressure can be reduced from the air spring to accommodate different rider styles and or terrain. This auto sag feature can be achieved electronically as well, by having the tube assembly 124, 124′ in the shock, and the shock model data allowing the controller 300 to adjust spring preload (e.g. air pressure) appropriately for the given model (as determined by the controller 300 in a query) what sag measurement it should achieve. An electronically controlled pressure relief valve may be utilized to bleed off air spring pressure until the tube assembly 120 determines the shock is at its' proper sag. The pressure relief valve may then be directed to close. Proper sag may be achieved.

In a number of embodiments, the controller 300 would then walk the user 600 through a proper set up routine, starting with sag for example. The user 600 would sit on the bike and the rider sag measurement for the fork 5 and shock absorber 122, 122′ would be displayed on the communication device 500 for example. The controller 300 will know what suspension assembly 120 component it is trying to get adjusted properly and will make pressure recommendations for the user 600 to input to the shock 122, 122′ or fork 5. The user 600 will then sit on the bike again, and in this iterative and interactive process, arrive at a desirable sag setting for the fork 5 and shock absorber 122, 122′ being used. In a more elaborate system, the controller 300 will “know” what pressure is in the fork 5 and shock 122, 122′, and will make rebound recommendations based on those settings. In a simpler form, the controller 300 will ask the user 600 to input their final sag attaining pressures and will then make rebound recommendations based on the pressures. The controller 300 will also make compression damping setting recommendations based on the vehicle 100 it knows it is communicating with. The user 600 will then go out and ride the vehicle 100. The controller 300 will transfer to data logging mode once the bike is being ridden or in a simpler form when the user 600 puts the system 1000 into ride mode. The controller 300 will log and save bottom out events, average travel used, identify too quick or too slow rebound events, etc. If average travel is more than a specified amount, the controller 300 will make recommendations on settings to have the system hold itself up better in the stroke. If the average travel used in less than a specified amount the controller 300 will make recommendations on settings to utilize more travel. Full travel events will be evaluated versus the average travel used data and make recommendations on how to reduce or increase the amount of full travel events. Computer (PC/laptop) software will be developed so the data logged can be downloaded to the computer system 400 for further evaluation. A website, can be utilized as a place for riders to go to check out settings other riders are using and why, and to provide a way to compare data and spend time in a community. In one embodiment, the controller 300 will log ridden hours and will prompt the user 600 to perform certain maintenance operations, and when data is downloaded to the computer system 400, such as a desktop/laptop machine, a link to the service procedure for the particular recommended service will pop up. The link will be to a video guild on how to perform the service, tools needed etc., if a user 600 is at the max of a particular adjustment feature, the controller 300 will make a recommendation to have a service provider, re-equip their system to get that particular adjustment feature into the proper level, and will make recommendations to a service technician on what direction to make the suspension assembly 120 changes, etc.

In one embodiment, the system 1000 may include one or more of the following features: a processor to actively process tube assembly 120 data and adjust opening of valve accordingly; a wireless communication to vehicle handlebar mounted control console (also rear shock compatible); an adjustable manual mechanical blow-off; an electronic wirelessly adjustable blow-off; an adjustable “g” threshold to open valve; an adjustable “timer” to dose valve; an adjustable low speed bleed (which could be a separate adjustment, or a trim adjustment of the main on-off valve); a program mode where it automatically alters open and closing parameters based on tube assembly 120 input (for example sensing a rock garden); auto (Inertia sensing)/On (always lockout)/Off (no lockout) modes; a wheel speed measurement device that can also dictate how the fork responded; a travel measurement device either for bottom out, or discrete travel points (to aid in proper sag); and a data storage.

In one embodiment, the system 1000 may include one or more of the following features: battery charging via base stud with cap (similar to 36/40); all battery/sensing/actuation at bottom of cartridge; manual mechanical rebound adjust on top; on/off and/or auto on/off switch or system; a GPS could be incorporated to program in sections for race courses, either ahead of time, or on the fly for multi lap races (this could even be used for a DH course with a prolonged pedaling section).

FIG. 5 illustrates a block diagram of the controller 300 according to one embodiment. The controller 300 may include a water-proof housing (and shock resistant components or potting) having a front panel 310 and a rear panel 320. The front panel 310 may comprise a connection assembly 311, such as a universal serial bus (“USB”) port, for data read-out and/or power or battery charging; a switch 312, such as a momentary contact switch for turning the controller 300 on and off; and an indicator 313, such as a light emitting diode (“LED”) for on/off and power or battery status. The controller may include an electronic device running on a coin cell lasting from about 6 to about 12 months at a time. The rear panel 320 may comprise one or more analog inputs 321, such as eight analog inputs each having 10 bit, 500 Hz SR, and 5V ratio-metric communication features; and one or more digital inputs 322, such as eight digital inputs for communication with Reed/Hall-type switches. The analog and digital tube assembly 120 signals received by the inputs 322, 321 may be communicated to one or more ESD and/or signal conditioning devices 330. The rear panel 320 may comprise a serial port 323/324 for communication with one or more serial devices, such as GPS and Bluetooth; and a power output 325 for transmitting a 5V and/or 20 mA signal. Each of the components and/or devices in communication with the controller 300 via the front and rear panels may also communicate with a processor 340 of the controller 300.

The processor 340, such as a microprocessor or micro-computer, may communicate with a ANT radio frequency transceiver 343 (e.g. ANT AP2 module, 20×20×3 mm surface-mount), a memory card socket 342 (for communication with a SD card (2GB), for example), a debug serial interface 341, and one or more analog inputs 344, such as four analog inputs for self-test including Li-polymer battery voltage, +3.3V logic power supply, +5.0V measurement device supply, and internal temperature measurement device (e.g. LM34-type). The controller 300 may also include a power system 350 including a battery 351, a battery charger 352, and one or more converters 353, 354, such as voltage converters. In one embodiment, the battery 351 may be a Li-polymer battery with the following features: 850 mA-hr charge, about 36 mm×62 mm×3.9 mm dimensions, and a 90 minute charge from USB with about an 8-plus hour operating life. In one embodiment, the converter 353 may be a voltage converter operable to provide a +5.0V power signal to one or more tube assemblies 122, 122′ in communication with the controller 300. In one embodiment, the converter 354 may be a voltage converter operable to provide a +3.3V power signal to processor 340 and one or more components in communication with the processor. In one embodiment, the components of the controller 300 may provided on a printed circuit assembly size of about 1.6″×3.0″×0.3″ in dimension, including a 0.062″ thick circuit 6-layer circuit board, a 0.200″ top-side max component height, and/or a 0.040″ bottom-side max component height. In one embodiment, the processor 340 may be configured to send and/or receive one or more signals to and from the other components of the controller 300 for use with the embodiments described herein.

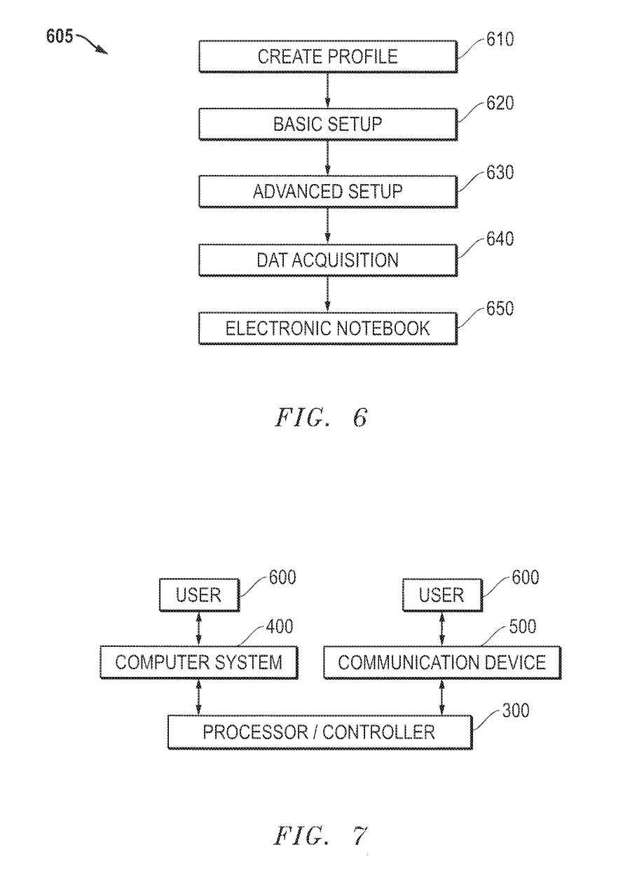

FIG. 6 illustrates a block diagram of a software program 605 that may be used with the system 1000, according to one embodiment. FIGS. 7-11 illustrate a block diagram example of each step of the software program 605 process. The steps used with the software program 605 may be performed and/or repeated in any order.

A first step 610 may include creating a profile. As illustrated in FIG. 7, data about the vehicle 100 and the user 600 may be entered by the user 600 on the computer system 400 (e.g. PC, laptop, etc.) and/or on the communication device 500 (e.g. iPhone, iPod, Garmin, other interface devices, etc.). The computer system 400 may be configured with the full features of the software program, and may include a hard drive to store the vehicle 100 and user 600 data, which data may also be saved to the controller 300. The communication device 500 may include a minimal set of essential questions to be answered by the user 600, the responses to which may be communicated to the controller 300. The data may be stored on the computer system 400 and/or the communication device 500, and may also be sent and stored on the controller 300. The controller 300 may include a storage directory that can transfer and/or receive data from the computer system 400 and/or the communication device 500. Data regarding the basic and advanced setup (further described below) may be stored in the controller 300 in an alternate location on a memory card to be used internally. Several profiles can be stored on the controller 300 for use with different vehicles 100. The computer system 400 and/or communication device 500 can be used to select the profile to activate on the controller 300.

A second step 620 may include setting up basic vehicle 100 parameters. The software program for use with the system 1000 may assist shops and individuals with basic setup parameters of their vehicle 100 components, such as the vehicle suspension. The software program may run on all interface platforms, and may bring the user 600 through a step by step structured procedure to set up the vehicle 100 component based on the data of the vehicle 100 and the user 600 from the profile, as well as specific riding conditions and style anticipated. In one embodiment, the software program may work without the controller 300, but without automatic measurement and some limitations.

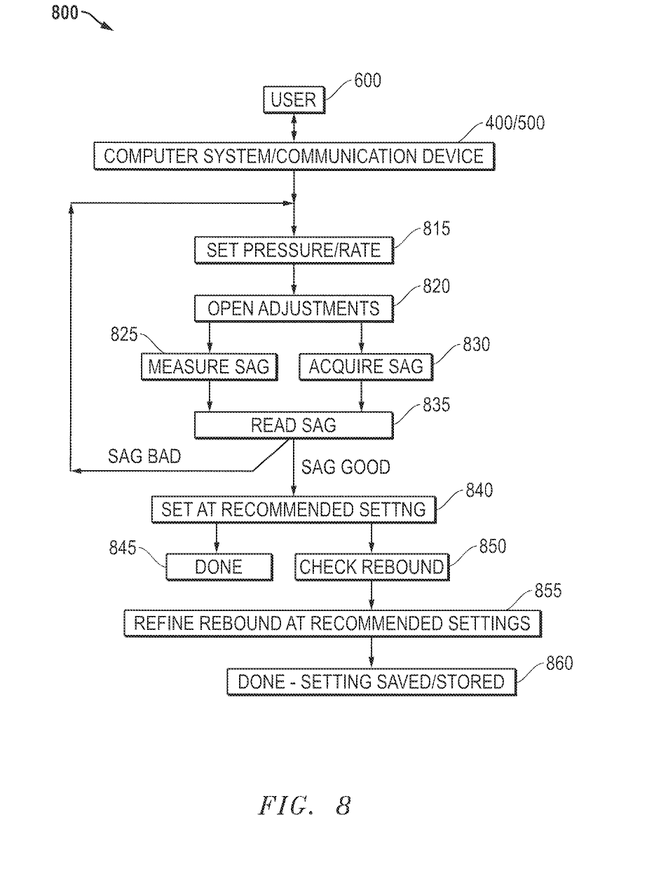

FIG. 8 illustrates a procedural example 800 of the second step 620 used to set up basic vehicle 100 suspension system parameters. In particular, the user 600 communicates with the computer system 400 and/or the communication device 500 as described in the first step 610 to provide user 600 and vehicle 100 data, which the software program may then use to guide the user 600 through a set up procedure. In one embodiment, the data may be manually entered if no controller 300 is present. A first command prompt 815 may instruct the user 600 to set shock absorber 122, 122′ pressures and spring rates based on vehicle type, user weight and style. A second command prompt 820 may instruct the user 600 to open the vehicle 100 damping component 8, 8′ adjustment. If the controller 300 is not available, a third command prompt 825 may instruct the user 600 to get on the vehicle 100, bounce, and measure the sag. If the controller 300 is available, a fourth command prompt 830 may instruct the user 600 to get on the vehicle 100 and bounce, so that the controller 300 can acquire the sag. A fifth command prompt 835 may instruct the user 600 to read the percentage sag, and if the sag is bad, the user 600 may be directed to the first prompt 815 to repeat the procedure. However, if the sag reading is good, then a sixth prompt 840 may instruct the user 600 to set the shock absorber 122, 122′ and damping component 8, 8′ at recommended settings. If the controller 300 is not available, a seventh command prompt 845 may notify the user 600 that the basic set up procedure is complete. If the controller 300 is available, an eighth command prompt 850 may instruct the user 600 to compress the vehicle's 100 front and rear suspension against the ground and then pick the vehicle 100 up off the ground quickly to acquire/check rebound settings. A ninth prompt 855 may instruct the user 600 to refine the rebound to a recommended setting. A final prompt 860 may notify the user 600 that the basic set up procedure is complete and/or that the final set up parameters have been saved and stored.

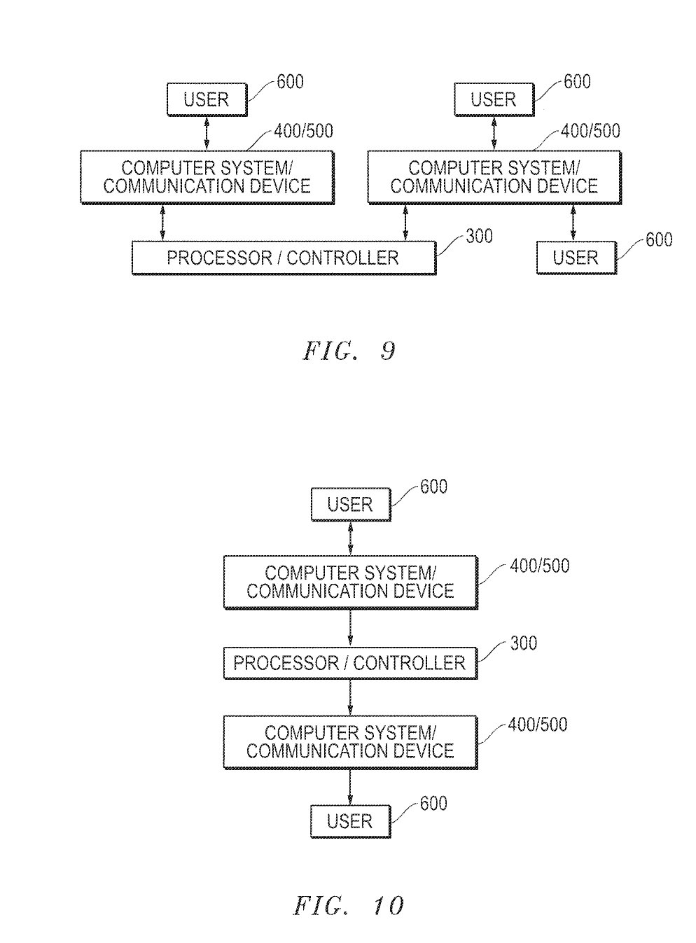

A third step 630 may include setting up advanced vehicle 100 parameters. As illustrated in FIG. 9, the user 600 may set the controller 300 via the computer system 400 and/or communication system 500 into an advanced setup mode where it collects data from the tube assembly 124, 124′ and processes the data. The controller 300 may collect data while riding the vehicle 100 and process the data with parameters from the profile created in the first step 610. In one embodiment, when in the advanced setup mode, the controller 300 collects data from front and rear position, as well as the wheel speed measurement device (and any additional measurement devices that may be used) for example during the operation of the vehicle 100. The data is processed to collect significant metrics such as maximum compression and rebound velocities, number of bottom outs, average ride height, and/or pedal bob detection. The data results may be updated and stored in an onboard memory device. When connected back to the computer system 400 and/or communication device 500 at the end of the operation of the vehicle 100, a series of questions may be prompted by the controller 300 to the user 600. The questions may be displayed in a fixed format on a user interface or display of the computer system 400 and/or the communication device 500. Based on the answers to the questions provided by the user 600 and the processed data, suggestions will be made to the user 600 as how to further refine the vehicle 100 setup. This may be an interactive process so the process can be repeated to continue to develop the vehicle 100 setup.

A fourth step 640 may include acquiring data from the tube assembly 120 about the operation of the vehicle 100. As illustrated in FIG. 10, the user 600 may set the controller 300 via the computer system 400 and/or communication system 500 into a data acquisition mode where it collects and stores raw data from the tube assembly 120. In one embodiment, when in the data acquisition mode, the controller 300 collects data from front and rear position, as well as the wheel speed measurement devices (and any additional measurement devices that may be used) for example during the operation of the vehicle 100. The controller 300 may collect the data while riding the vehicle 100 and store the data on the memory card without processing the data. When connected back to the computer system 400 and/or communication device 500 at the end of the operation of the vehicle 100, the data can be downloaded thereto and analyzed. Additional post processing may be performed on the data once downloaded to assist in the analyzing of the data. The computer system 400 and/or communication device 500 can be used to graphically display the data and allow for manipulation, such as through math channels and overlaying data. The software program on the computer system 400 and/or communication device 500 may generate reports, such as histograms of travel, damping component speeds, and pedal bob detection. The data acquisition may be thought of as an advanced function, so it may be left to the user 600 to interpolate the data and decide on changes to make. An instructional guide may be provided.

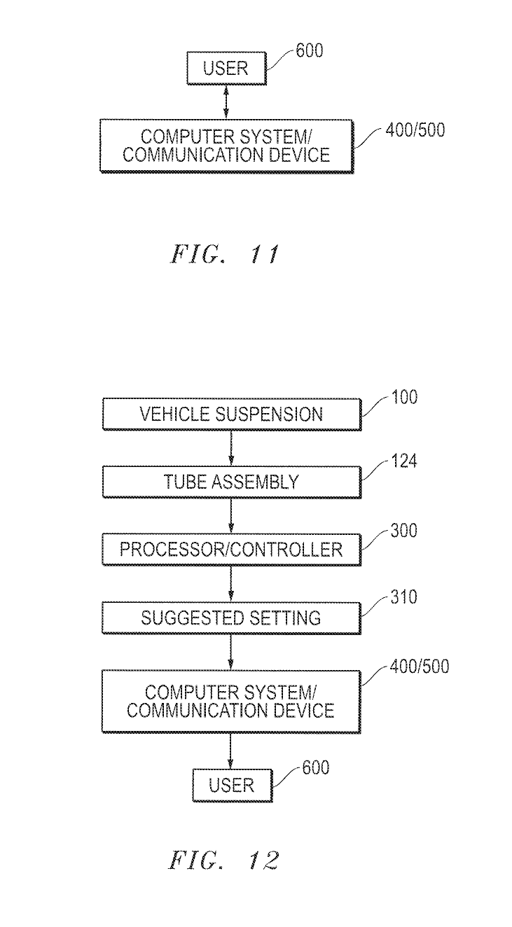

A fifth step 650 may include setting up an electronic file, such as an electronic notebook. As illustrated in FIG. 11, the user 600 may create, edit, and view the electronic notebook using the computer system 400 and/or the communication device 500. The electronic notebook can be used to track vehicle 100 setups and user 600 notes about the vehicle handling, as well as general notes about races, rides, and conditions. Vehicle setups will be able to be saved to the electronic notebook from the profile created in the first step 610 described above. The vehicle setups can be transferred back to the controller 300, the computer system 400, and/or the communication device 500 to run the basic and/or advance set up procedures for different events and/or vehicles. Tracking changes to the vehicle will be one of the key features of the software program so that a history/database of what changes were made to the vehicle 100 and what effect they had will be compiled. The electronic notebook can be searchable so that a symptom can be searched and possible past solutions can be easily found.

In one embodiment, the system 1000 may be used to acquire performance data, including the operation of one or more components of the vehicle 100 and the location of the vehicle 100, during operation of the vehicle 100. The performance data may be associated with a time maker to track the actual time when the performance data was measured. Using the system 1000, the user 600 can utilize the performance data to correlate the actual location of the vehicle 100 at a specific time to a specific operational characteristic of a component of the vehicle 100. In this manner, the user 600 may be able to plot a course over which the vehicle 100 can be operated, and adjust the vehicle 100 components to an optimum setting as the vehicle 100 may be operated along the course.

In one embodiment, the user 600 may be able to view the data acquired by the controller 300 during operation of the vehicle 100 via the communication device 500, which may be coupled to the vehicle 100 in any manner for ease of viewing. In one embodiment, the user 600 may be able to view the data acquired by the controller 300 during and/or after operation of the vehicle 100 via the computer system 400 and/or the communication device 500. In one embodiment, the controller 300 may be operable to acquire data from the tube assembly 120 coupled to the vehicle 100 at pre-determined intervals. In one embodiment, the controller 300 may be operable to automatically adjust (increase, decrease, maintain) the intervals at which to acquire data from the tube assembly 124, 124′ based on the operating performance of the components of the vehicle 100.

FIG. 12 illustrates a block diagram of one process of use with the system 1000 according to the embodiments described herein. As illustrated, during, prior to, and/or after operation of the vehicle 100, the tube assembly 120 may measure an operational feature of one or more components of the vehicle 100, such as the travel of the vehicle suspension. The processor or controller 300 may be operable to receive the measurement data from the tube assembly 120 via wired and/or wireless communication. The processor or controller 300 may analyze the data and compare the data to pre-programmed vehicle suspension operational settings that may be stored on the processor or controller 300. Based on the analysis, the processor or controller 300 may output a suggested vehicle setting 310 to the computer system 400 and/or communication device 500 via wired and/or wireless communication. The suggested vehicle setting 310 may be displayed on the computer system 400 and/or communication device 500, and may be in the form of an instruction regarding an adjustable feature of the vehicle 100 suspension and/or a rendition of the measurement data that will aid the user 600 in evaluating the setting of an adjustable feature of the vehicle 100 suspension.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “device,” “tube assembly,” “processor,” “controller,” or “system,” such as system 1000. Furthermore, aspects of the invention (such as one or more embodiments of the vehicle 100, the tube assembly 124, 124′, the processor or controller 300, the computer system 400, and/or the communication device 500) may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that may not be a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the invention (such as one or more embodiments of the vehicle 100, the tube assembly 124, 124′, the processor or controller 300, the computer system 400, and/or the communication device 500) may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks illustrated in one or more of FIGS. 1-12.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks illustrated in one or more of FIGS. 1-12.

The provided suspension assembly 120 and sensor-less measurement system 1000 may enable sensor-less measurement of vehicle 100 parameters through the tube assembly 120. In other words, no sensors may be placed on the vehicle 100 or suspension assembly 120 itself to monitor these parameters. In a number of embodiments, the suspension assembly 120 may be monitored on existing vehicles through the measurement device 80 without any modification of the vehicle 100 or suspension assembly 120 necessary. In other words, additional components or modifications may not be necessary to use the system 1000.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1: A suspension assembly comprising: a tube assembly comprising: a hollow outer tube, and a hollow inner tube fitted within the outer tube and adapted to be slidably engageable with the outer tube, wherein the tube assembly is adapted to contain at least one of (i) a damping element to control relative movement between the inner tube and the outer tube, and (ii) a spring element adapted to resist a force applied to the tube assembly; and a sensor-less measurement system adapted to measure the capacitance between the inner tube and the outer tube, wherein relative movement between the inner tube and the outer tube is derived from the change in measured capacitance between the inner tube and the outer tube.

Embodiment 2: A method comprising: providing a suspension assembly comprising: a tube assembly comprising: a hollow outer tube, and a hollow inner tube fitted within the outer tube and adapted to be slidably engageable with the outer tube, wherein the tube assembly is adapted to contain at least one of (i) a damping element to control relative movement between the inner tube and the outer tube, and (ii) a spring element adapted to resist a force applied to the tube assembly; and a sensor-less measurement system adapted to measure the capacitance between the inner tube and the outer tube, wherein relative movement between the inner tube and the outer tube is derived from the change in measured capacitance between the inner tube and the outer tube; measuring the capacitance between the inner tube and the outer tube over time; and deriving the relative movement between the inner tube and the outer tube from the change in measured capacitance between the inner tube and the outer tube.

Embodiment 3: An assembly or method of any of the preceding embodiments, wherein the spring element is disposed within the outer tube and is adapted to provide spring force between the inner tube and the outer tube.

Embodiment 4: An assembly or method of any of the preceding embodiments, wherein the damping element comprises a fluid and disposed within the outer tube, and wherein the damping element is adapted to restrict fluid flow so as to damp relative movement between the inner tube and the outer tube.

Embodiment 5: An assembly or method of any of the preceding embodiments, wherein no capacitive shortcut exists between the inner tube and the outer tube.

Embodiment 6: An assembly or method of any of the preceding embodiments, wherein the measurement system comprises: an electrical contact to the inner tube and an electrical contact to the outer tube; and a measurement device adapted to measure capacitance between the inner tube and the outer tube.

Embodiment 7: An assembly or method of embodiment 6, wherein the measurement device comprises a microcontroller.

Embodiment 8: An assembly or method of embodiment 6, wherein the measurement device is wirelessly coupled to the electrical contact.

Embodiment 9: An assembly or method of embodiment 6, wherein the measurement device further comprises at least one of a computer system or a communication device, each operable to communicate with the processor and display data corresponding to the operational characteristic measured by the measurement device.

Embodiment 10: An assembly or method of embodiment 9, wherein the communication device includes a software program operable to generate the information based on the data received from the processor.

Embodiment 11: An assembly or method of embodiment 9, wherein the computer system or communication device includes at least one of a personal desktop computer, a laptop computer, a cellular phone, or a hand-held personal computing device.

Embodiment 12: An assembly or method of embodiment 9, wherein the at least one computer system and communication device is operable to adjust the vehicle suspension to the operational setting suggested by the processor.

Embodiment 13: An assembly or method of any of the preceding embodiments, wherein a dielectric gap exists radially between the inner tube and the outer tube.

Embodiment 14: An assembly or method of embodiment 6, wherein the dielectric gap comprises air.

Embodiment 15: An assembly or method of embodiment 6, wherein the dielectric gap comprises a conductive material.

Embodiment 16: An assembly or method of any of the preceding embodiments, wherein at least one of the inner tube or the outer tube comprise a polymer.

Embodiment 17: An assembly or method of any of the preceding embodiments, wherein the position of the inner tube or outer tube of the tube assembly corresponds to a stroke of the suspension assembly during compression or rebound of a vehicle.

Embodiment 18: An assembly or method of any of the preceding embodiments, wherein the suspension assembly includes at least one of a front suspension and a rear suspension of a vehicle.

Embodiment 19: An assembly or method of any of the preceding embodiments, wherein the vehicle is a bicycle or motorbike.

Embodiment 20: A sensor-less measurement system adapted to measure the capacitance between the inner tube and the outer tube, wherein relative movement between the inner tube and the outer tube is derived from the change in measured capacitance between the inner tube and the outer tube.

Embodiment 21: An assembly comprising: a hollow outer tube, and a hollow inner tube fitted within the outer tube and adapted to be slidably engageable with the outer tube; and a sensor-less measurement system adapted to measure the capacitance between the inner tube and the outer tube, wherein relative movement between the inner tube and the outer tube is derived from the change in measured capacitance between the inner tube and the outer tube.

Embodiment 22: A method comprising: providing an assembly comprising: a tube assembly comprising: a hollow outer tube, and a hollow inner tube fitted within the outer tube and adapted to be slidably engageable with the outer tube; and a sensor-less measurement system adapted to measure the capacitance between the inner tube and the outer tube, wherein relative movement between the inner tube and the outer tube is derived from the change in measured capacitance between the inner tube and the outer tube; measuring the capacitance between the inner tube and the outer tube over time; and deriving the relative movement between the inner tube and the outer tube from the change in measured capacitance between the inner tube and the outer tube.

Note that not all of the features described above are required, that a portion of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range, including the end range values referenced. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

What is claimed is:

1. A suspension assembly comprising:
a tube assembly comprising:
a hollow outer tube, and
a hollow inner tube fitted within the outer tube and adapted to be slidably engageable with the outer tube, wherein the tube assembly is adapted to contain at least one of (i) a damping element to control relative movement between the inner tube and the outer tube, and (ii) a spring element adapted to resist a force applied to the tube assembly; and
a sensor-less measurement system adapted to measure the capacitance between the inner tube and the outer tube, wherein relative movement between the inner tube and the outer tube is derived from the change in measured capacitance between the inner tube and the outer tube.

2. A method comprising:
providing a suspension assembly comprising:
a tube assembly comprising:
a hollow outer tube, and
a hollow inner tube fitted within the outer tube and adapted to be slidably engageable with the outer tube, wherein the tube assembly is adapted to contain at least one of (i) a damping element to control relative movement between the inner tube and the outer tube, and (ii) a spring element adapted to resist a force applied to the tube assembly; and
a sensor-less measurement system adapted to measure the capacitance between the inner tube and the outer tube, wherein relative movement between the inner tube and the outer tube is derived from the change in measured capacitance between the inner tube and the outer tube;
measuring the capacitance between the inner tube and the outer tube over time; and
deriving the relative movement between the inner tube and the outer tube from the change in measured capacitance between the inner tube and the outer tube.

3. The assembly of claim 1, wherein the spring element is disposed within the outer tube and is adapted to provide spring force between the inner tube and the outer tube.

4. The assembly of claim 1, wherein the damping element comprises a fluid disposed within the outer tube, and wherein the damping element is adapted to restrict fluid flow so as to damp relative movement between the inner tube and the outer tube.

5. The assembly of claim 1, wherein no capacitive shortcut exists between the inner tube and the outer tube.

6. The assembly of claim 1, wherein the measurement system comprises:
an electrical contact to the inner tube and an electrical contact to the outer tube; and
a measurement device adapted to measure capacitance between the inner tube and the outer tube.

7. The assembly of claim 6, wherein the measurement device comprises a microcontroller.

8. The assembly of claim 6, wherein the measurement device is wirelessly coupled to the electrical contact.

9. The assembly of claim 6, wherein the measurement device further comprises at least one of a computer system or a communication device, each operable to communicate with the processor and display data corresponding to the operational characteristic measured by the measurement device.

10. The assembly of claim 9, wherein the communication device includes a software program operable to generate the information based on the data received from the processor.

11. The assembly of claim 9, wherein the computer system or communication device includes at least one of a personal desktop computer, a laptop computer, a cellular phone, or a hand-held personal computing device.

12. The assembly of claim 9, wherein the at least one computer system and communication device is operable to adjust the vehicle suspension to the operational setting suggested by the processor.

13. The assembly of claim 1, wherein a dielectric gap exists radially between the inner tube and the outer tube.

14. The assembly of claim 1, wherein the dielectric gap comprises air.

15. The assembly of claim 1, wherein the dielectric gap comprises a conductive material.

16. The assembly of claim 1, wherein at least one of the inner tube or the outer tube comprise a polymer.

17. The assembly of claim 1, wherein the position of the inner tube or outer tube of the tube assembly corresponds to a stroke of the suspension assembly during compression or rebound of a vehicle.

18. The assembly of claim 1, wherein the suspension assembly includes at least one of a front suspension and a rear suspension of a vehicle.

19. The assembly of claim 1, wherein the vehicle is a bicycle or motorbike.

20. An assembly comprising:
a hollow outer tube, and
a hollow inner tube fitted within the outer tube and adapted to be slidably engageable with the outer tube; and
a sensor-less measurement system adapted to measure the capacitance between the inner tube and the outer tube, wherein relative movement between the inner tube and the outer tube is derived from the change in measured capacitance between the inner tube and the outer tube.
